(19) United States
(12) Patent Application Publication
(10) Pub. No.: US 2011/0053450 A1
(43) Pub. Date: Mar. 3, 2011

(54) TEXTILE EMBELLISHMENTS THAT PERMANENTLY BOND TO WATERPROOF AND/OR WATERPROOF-BREATHABLE FABRICS

(76) Inventors: Navaid Baqai, Hanover, PA (US); Paul Weedlun, Ellicott City, MD (US)

(21) Appl. No.: 12/942,628

(22) Filed: Nov. 9, 2010

Related U.S. Application Data
(63) Continuation-in-part of application No. 12/387,718, filed on May 6, 2009.

(51) Int. Cl. B44C 1/165; B32B 37/12; B32B 27/12; B32B 27/36

(52) U.S. Cl. 442/286; 156/331.7; 442/304; 442/394

(57) ABSTRACT

A new product and process for producing an integrated textile embellishments such as patches, emblems, appliqués, labels and cut textile parts (including woven, knits and nonwoven structures made of both natural and or synthetic fibers) incorporating adhesives that permanently bond by heat-sealing to waterproof and/or waterproof-breathable fabrics including Gore-Tex®, Sympatex™ and other fabrics having durable water repellant finishes (DWR). This eliminates the tedious and cost intensive sewing operations previously needed to attach textile embellishments to such fabrics. The product and process includes a top layer decorative element, a second layer bonded to the top layer through lamination or chemical bonding to create a more uniform or smooth surface, and a thermal adhesive layer bonded to the second layer and capable of heat-application to textile based textile based products such as apparel and or accessories, headwear, outdoor furnishings and luggage. Products of this type can survive multiple washes and are desired by manufactures for their ease of application, saving time, money and reducing complexity in the application process

### CROSS-REFERENCE TO RELATED APPLICATION(S)

The present invention is a continuation-in-part of U.S. patent application Ser. No. 12/387,718 filed May 6, 2009.

### BACKGROUND OF THE INVENTION

1. Field of the Invention

The present invention relates generally to methods for producing textile embellishments such as patches, emblems, appliqués, labels, etc., and more particularly to a new product and process for producing textile embellishments with adhesive properties that permanently bond to waterproof and/or waterproof-breathable fabrics including Gore-Tex®, Sympatex™ and other fabrics having durable water repellant finishes (DWR).

2. Description of the Background

There is a commercial demand for textile embellishments that can be quickly and easily applied to products such as apparel and or accessories, headwear, outdoor furnishings and luggage. An embroidered appearance or decoration can instantly be accomplished by bonding a patch, emblem, appliqué, label or other cut textile component onto a product by heat-seal application, provided that a durable and uniform bond can be attained that withstands home laundering and dry cleaning.

Waterproof fabrics and waterproof/breathable fabrics resist water droplets from passing through the fabric, the latter also allowing water vapor through. Waterproof fabrics are usually natural or synthetic fabrics that are laminated to or coated with a permanent waterproofing material, such as rubber, polyvinyl chloride (PVC), polyurethane (PU), silicone elastomer, or wax. Waterproof/breathable fabrics often employ a DWR (Durable Water Repellent) coating to make them water-resistant (or hydrophobic). The ability to block out rain and snow makes waterproof fabrics well-suited for use in outdoor environments, and added breathability (allowing vapor from sweat to evaporate) makes such fabrics perfect for use in outdoor sports. However, it is notoriously difficult to bond decorative embellishments to such fabrics. Currently, the known method available to manufacturers who wish to permanently apply textile embellishments has been to sew the decorative embellishment to the waterproof apparel, outdoor furnishing, luggage, etc. Of course, penetration detracts from the waterproof nature, and so to preserve it manufacturers apply a patch of adhesive material behind the stitched area (on the inside or underside) to seal the perforation from the sewing process. This requires additional investment in time, equipment and labor.

Although manufacturers have heretofore sought to customize articles in small batches economically they have been limited to large orders where economics warrant the expenditure associated with sewn-in decorations in panels prior to final assembly of garments. For smaller quantity orders, however, sewing onto panels or sections of the apparel, outdoor furnishings or luggage is costly and time consumptive.

There are existing methods for using heat-sealable adhesives to bond seams in garments. However, these methods do not work with embellishments which tend to have non-uniform surfaces, multiple surrounding sides, and higher profile edges that are exposed to sheer forces from contact during the course of normal wear. Moreover, during laundering the sheer forces and penetration of cleaning solvents (water or dry cleaning fluids) quickly degrades and weakens or destroys the adhesive bond of embellishments to garments.

What is needed is a new and effective way of applying a textile embellishment to waterproof and/or waterproof-breathable textile products that does not require additional time consuming and labor intensive sewing and/or sealing steps.

The present inventors have developed a new method for producing integrated textile embellishments such as patches, emblems, appliqués, labels and cut textile parts including woven, knits and nonwoven structures made of both natural and or synthetic fibers incorporating a urethane based adhesive which does not require such additional time consuming and labor intensive sewing and sealing operations.

### SUMMARY OF THE INVENTION

It is, therefore, a primary object of the present invention to provide a textile embellishment with adhesive properties that permanently bond to waterproof and/or waterproof-breathable fabrics including Gore-Tex®, Sympatex™ and other fabrics having durable water repellant finishes (DWR), as well as a process for production thereof.

In accordance with the foregoing objects, the present invention is an improved method for producing an integrated textile embellishment capable of adhering to textile based products which requires no minimum product quantity, and which is less time consuming and labor intensive than previous methods known in the art. The resulting adhesive-backed textile embellishment can be produced and applied to the consumer textile based products such as apparel and accessories, outdoor furnishings or luggage.

The textile embellishment comprises a base substrate of natural or synthetic textile fibers formed into a woven, knit or nonwoven sheet. The base sheet may be further decorated through several possible combinations of techniques including dyeing, screen printing, sublimation printing, direct digital printing, embossing, etching, engraving, flocking, jacquard weaving, stitching, embroidery or appliquéing multiple layers of materials which are then cut out into decorative shapes or patterns.

A secondary layer is applied to the bottom side of the base sheet to create a chemical or mechanical bond that creates a smoother, lower surface energy, non-water soluble surface. The secondary layer may be applied by liquid, spray or foam application of a dispersion which is then dried or cured, or a dry application of thermoplastic(s) in powdered or film form that are then fused with heat and pressure. In a preferred embodiment the secondary layer is a polyester base film that has excellent bonding compatibility to urethane adhesives. This secondary layer and its compatibility to the tertiary adhesive layer (described below) are critical in creating a sustainable bond between the textile embellishment and the waterproof and/or waterproof-breathable product to which it is applied.

Given the base substrate with secondary layer applied to the bottom side, a tertiary adhesive layer is then applied to the bottom of the secondary layer. In a preferred embodiment the tertiary layer is a urethane based adhesive. The tertiary adhesive layer needs to have the ability to bond too low surface energy substrates and establish a washable, sustainable bond, and a polyurethane adhesive with the particular properties described below accomplish this.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a partial top plan view of the upper portion an integrated textile embellishment capable of adhering to waterproof and/or waterproof/breathable textile-based products in accordance with the present invention;

FIG. 2 is a cross sectional plan view of an integrated textile embellishment as in FIG. 1.

FIG. 3 is a cross sectional plan view of an integrated textile embellishment as in FIGS. 1-2 adhered to the top surface of a textile based product.

FIG. 4 is overhead view of the integrated textile embellishment shown in FIG. 1 adhered to a textile based product.

### DETAILED DESCRIPTION OF THE PREFERRED EMBODIMENT

The present invention is a new product and process for producing textile embellishments with adhesive properties that permanently bonds to waterproof and/or waterproof-breathable fabrics including Gore-Tex®, Sympatex™ and other fabrics having durable water repellant finishes (DWR). The textile embellishments are fully “washable”, meaning that the subject material is capable of withstanding at least 20-30 home laundering cycles without serious degradation of the bond.

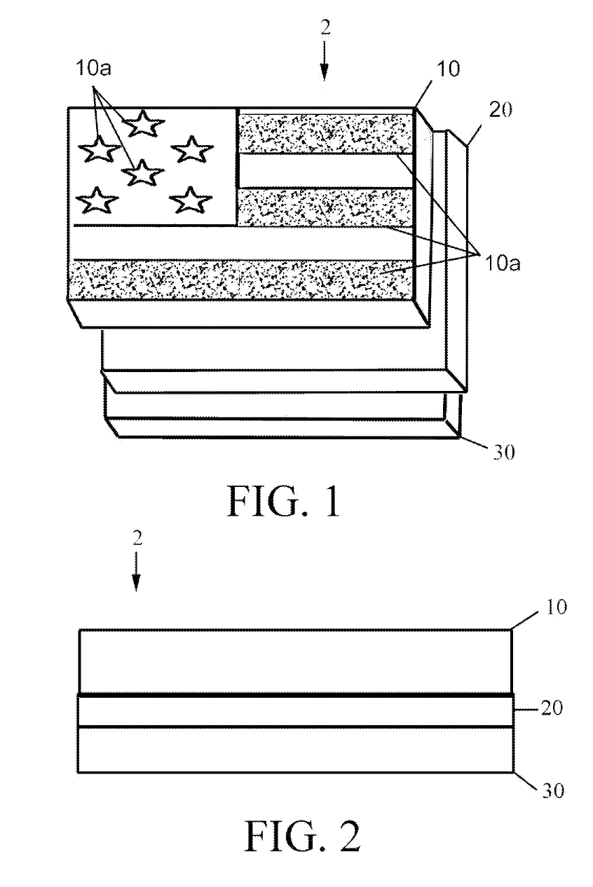

FIG. 1 is a partial top plan view of the textile embellishment 2. As shown in FIG. 1, the textile embellishment 2 comprises at least three (3) functional layers: a top layer 10, secondary layer 20, and thermal adhesive layer 30.

The top layer 10 is a base substrate of natural or synthetic textile fibers formed into a woven, knit or nonwoven sheet. The top layer 10 may be decorated through any one or a combination of possible techniques including dyeing, screen printing, sublimation printing, direct digital printing, embossing, etching, engraving, flocking, stitching, weaving, embroidery or appliquéing multiple layers of materials (10a) which are then cut out into decorative shapes or patterns.

FIG. 2 is a cross sectional plan view of an integrated textile embellishment as in FIG. 1. With combined reference to FIGS. 1-2, a secondary layer 20 is bonded chemically or mechanically onto the bottom surface of the top layer 10. Secondary layer 20 creates a smoother lower energy, flexible, non-water soluble surface on one side of the top layer 10. A chemical application of secondary layer 20 may be accomplished by either liquid or foam application of a dispersion which is then dried or cured. A mechanical application of secondary layer 20 may be by dry application of thermoplastics in powdered or film form, followed by fusing with heat and pressure. In a preferred embodiment the secondary layer is a polyester base film chosen for excellent bonding compatibility to urethane adhesives. This secondary layer and its compatibility to the tertiary adhesive layer 30 (described below) are critical in creating a sustainable bond between the textile embellishment and the waterproof and/or waterproof-breathable product 50 to which it is applied. Polyester has excellent compatibility with the urethane based adhesive layer 30 as described below. A suitable commercial example of a polyester secondary layer is a polyester film available from Tuftane Extrusion Technologies, Inc.

Next, in accordance with the present invention, as shown in FIG. 1 and FIG. 2, the secondary layer 20 is bonded mechanically on its bottom side (opposite the top layer 10), to a thermal adhesive layer 30. The thermal adhesive layer 30 is also water-resistant and capable of withstanding repeated wash cycles (at least 20-30 home laundering cycles).

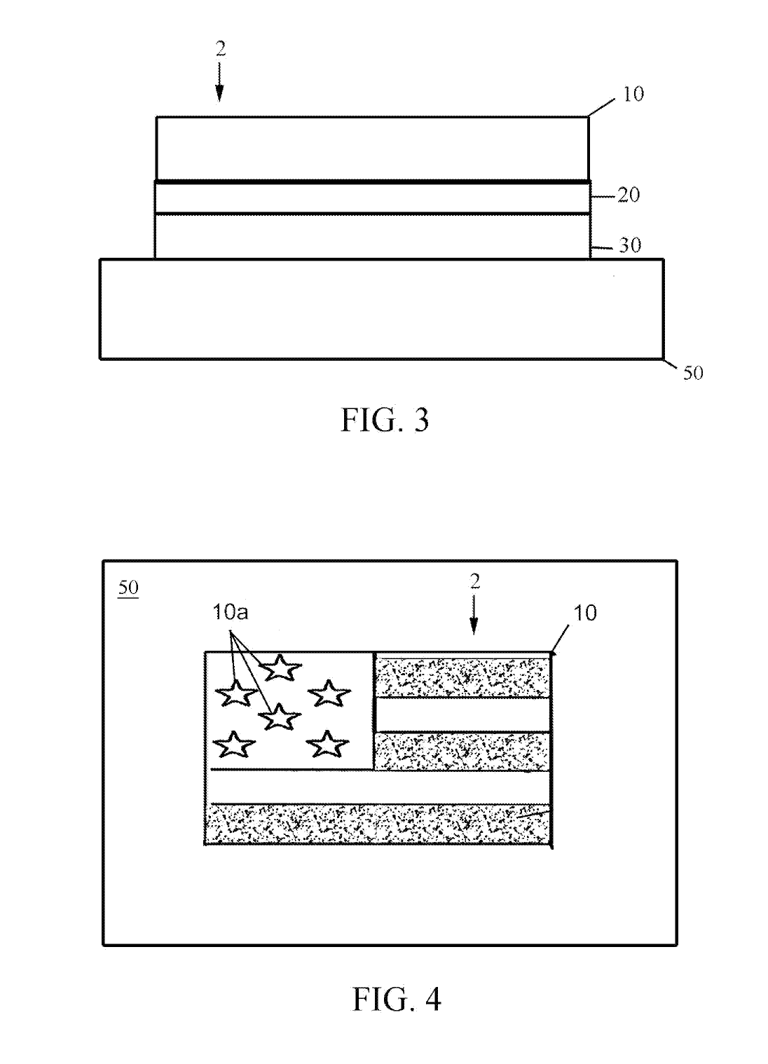

It is important to note that the selection of the secondary layer 20 and its compatibility to the tertiary thermal adhesive layer 30 is critical in creating a sustainable bond between the embellishment 2 and the waterproof and/or waterproof-breathable product 50 to which it is applied. Consequently, the preferred adhesive layer 30 is a urethane based adhesive that has the ability to bond to low surface energy substrates and establish a washable, sustainable bond via chemical or mechanical application of secondary layer 20. In a preferred embodiment adhesive layer 30 is a thin polyurethane adhesive layer having a thickness in a range of from 0.003-0.006″ and a glue-line temperature of approximately 310° F. for high-bond strength to DWR-coated fabric including Gore-Tex®, Sympatex™, PTFE (Teflon®) coated fabrics, and other fabrics having durable water repellant finishes (DWR). Suitable thermoplastic adhesives for the adhesive layer 30 of the present invention include urethane adhesives such as Bemis SEWFREE® 3405 urethane films produced by Bemis Associates Inc., or DureFlex PT7500 made by Deerfield Urethanes Inc. (a division of the Bayer Group), or similar urethane film. As seen in FIGS. 3-4, it will be noted that the thickness of both the secondary layer 20 adhesive and the adhesive layer 30 are also critical to the achieving a satisfactory bond between the embellishment 2 and the selected consumer textile product 50. Due to the typical irregular surface of uncoated textile products, sufficient adhesive must be present at the interface between the secondary layer 20 and the textile product 50 to which it is adhered in order to bond to the interstices or gaps between the surface of the secondary layer 20 and surface of the textile product 50. In the preferred embodiment, the thickness of the secondary layer 20 adhesive would be a in a range of 0.0025 to 0.005 inches and have a glue-line temperature of approximately 300° F. As described above, the tertiary thermal adhesive layer 30 would have a thickness in a range of 0.003 to 0.006 inches and a glue-line temperature of approximately 310° F.

To apply the finished textile embellishment 2, it is positioned over the waterproof and/or waterproof-breathable textile product 50 as shown in FIG. 3. Given proper positioning, the textile embellishment 2 may be heat-sealed against the waterproof and/or waterproof-breathable textile product 50, as shown in FIG. 4, thereby securely bonding the two together and essentially creating a “decorated” product that overlays the top of the waterproof and/or waterproof-breathable textile product 50 as shown in FIG. 4. Thus, with relative ease, apparel, outdoor furnishings or luggage can easily be decorated with a variety of embellishments.

The foregoing process may be used to decorate small quantities of waterproof textile products, as well as large quantities. The above process eliminates the cost prohibitive and labor intensive sewing and patching operations required for affixing embellishments and maintaining the waterproof condition of the product, decorators may now mass produce and embellish their textile products using a variety of embellishments on multiple job orders and for many different products.

The above-described embodiment is for the purpose of promoting an understanding of the principles of the invention. It should nevertheless be understood that no limitation of the scope of the invention is thereby intended, such alternations and further modifications in the illustrated device, and such further applications of the principles of the invention as illustrated herein being contemplated as would normally occur to one skilled in the art to which the invention relates.

1. A method of providing an integrated textile embellishment capable of providing a durable bond adhering to a waterproof and/or waterproof-breathable textile based product, comprising the steps of:
(a) providing a base substrate of textile fibers formed into a woven, knit or nonwoven sheet that is decorated on a first side;
(b) bonding a second layer of material to a second side of the base substrate to provide a smooth, low energy, non-water soluble surface on said second side of the base substrate;
(c) laminating a urethane based adhesive on a bottom side of said second layer of material that provide a wash durable, sustainable bond; and
(d) adhering said base substrate to said waterproof and/or waterproof-breathable textile based product at said urethane based adhesive in a manner to completely bond said urethane based adhesive, second layer material, and base substrate to said waterproof and/or waterproof-breathable textile based product;
whereby said adhered textile embellishment can withstand at least twenty laundering cycles without degradation of said bond.

2. The method of providing an integrated textile embellishment of claim 1, wherein said step of bonding a second layer of material to a bottom side of the base substrate comprises surface coating a polyester film to the bottom side of the base substrate topically from a solution.

3. The method of providing an integrated textile embellishment of claim 1, wherein said step of bonding a second layer of material to a bottom side of the base substrate comprises surface coating a polyester film to the bottom side of the base substrate through lamination.

4. The method of providing an integrated textile embellishment of claim 1, wherein said step of laminating a urethane based adhesive comprises laminating a thin polyurethane adhesive layer having a thickness in a range of from 0.003-0.006″ and a glue-line temperature of approximately 310° F.

5. The method of providing an integrated textile embellishment of claim 3, wherein said step of bonding a second layer of material to a bottom side of the base substrate comprises surface coating a thermoplastic film having a thickness within a range of from 0.0025 to 0.005 inches and a glue-line temperature of approximately 300° F.

6. The method of providing an integrated textile embellishment of claim 5, wherein said step of laminating a urethane based adhesive comprises laminating a thin polyurethane adhesive layer having a thickness in a range of from 0.003-0.006″ and a glue-line temperature of approximately 310° F.

7. An integrated textile embellishment for adherence to a waterproof and/or waterproof-breathable textile based product, comprising:
a base substrate of textile fibers formed into a woven, knit or nonwoven sheet;
a second layer material adhered to a bottom side of the base substrate to provide a smooth, low energy, non-water soluble surface on the bottom side of the base substrate;
a urethane based adhesive laminated on a bottom side of said second layer of material to provide a wash durable, sustainable bond;
whereby said embellishment may be thermally adhered by said base substrate to a waterproof and/or waterproof-breathable textile based product via said urethane based adhesive.

8. The integrated textile embellishment of claim 7, wherein said second layer of material comprises a surface-coated polyester film.

9. The integrated textile embellishment of claim 8, wherein said second layer of material comprises a thermoplastic polyester film laminated to the bottom side of the base substrate.

10. The integrated textile embellishment of claim 7, wherein said urethane based adhesive comprises a thin polyurethane adhesive layer having a thickness in a range of from 0.003-0.006″ and a glue-line temperature of approximately 310° F.

11. The integrated textile embellishment of claim 7, wherein second layer of material comprises a thermoplastic film having a thickness within a range of from 0.0025 to 0.005 inches and a glue-line temperature of approximately 300° F.

12. The integrated textile embellishment of claim 7, wherein said urethane based adhesive comprises a thin polyurethane adhesive layer having a thickness in a range of from 0.003-0.006″ and a glue-line temperature of approximately 310° F.

13. A method of providing an integrated textile embellishment capable of providing a durable bond adhering to a waterproof and/or waterproof-breathable textile based product, comprising:
a first step of providing a base substrate of textile fibers formed into a woven, knit or nonwoven sheet;
a second step of bonding a second layer of material to a bottom side of the base substrate to provide a smooth, low energy, non-water soluble surface on the bottom side of the base substrate;
a third step of laminating a urethane based adhesive on a bottom side of said second layer of material to provide a wash durable, sustainable bond; and
a fourth step of adhering said base substrate to said waterproof and/or waterproof-breathable textile based product at said urethane based adhesive in a manner to completely bond said urethane based adhesive, second layer material, and base substrate to said waterproof and/or waterproof-breathable textile based product;
whereby said adhered textile embellishment can withstand at least twenty laundering cycles without degradation of said bond.

14. The method of providing an integrated textile embellishment of claim 13, wherein said second step of bonding a second layer of material to a bottom side of the base substrate comprises surface coating a polyester film to the bottom side of the base substrate topically from a solution.

15. The method of providing an integrated textile embellishment of claim 13, wherein said second step of bonding a second layer of material to a bottom side of the base substrate comprises surface coating a thermoplastic film onto said second layer of material to the bottom side of the base substrate through lamination.

16. The method of providing an integrated textile embellishment of claim 13, wherein said third step of laminating a urethane based adhesive on a bottom side of said second layer of material comprises laminating a thin polyurethane adhesive layer having a thickness in a range of from 0.003-0.006″ and a glue-line temperature of approximately 310° F.

17. The method of providing an integrated textile embellishment of claim 16, wherein said step of bonding a second layer of material to a bottom side of the base substrate comprises surface coating a thermoplastic film having a thickness within a range of from 0.0025 to 0.005 inches and a glue-line temperature of approximately 300° F.

18. The method of providing an integrated textile embellishment of claim 18, wherein said third step of laminating a urethane based adhesive on a bottom side of said second layer of material comprises laminating a thin polyurethane adhesive layer having a thickness in a range of from 0.003-0.006″ and a glue-line temperature of approximately 310° F.

19. A method of manufacturing an appliqué suitable for thermal bonding to an article made of a waterproof textile, comprising the steps of:
providing a previously manufactured appliqué having an ornamental top side and a bottom side, the bottom side having a known surface energy;
applying to said bottom side of said embellishment a non-water soluble polyester film second having a surface energy equal to or less than the known surface energy of the bottom side of said previously manufactured appliqué;
laminating a urethane based thermal adhesive layer to an exposed side of said polyester film.

20. A method of durably bonding an embellishment to an article made of a waterproof textile, comprising the steps of:
providing a previously manufactured embellishment having a top side and a bottom side;
applying to said bottom side of said embellishment a second layer having a low energy, non-water soluble surface;
laminating a urethane based adhesive layer to said low energy, non-water soluble surface;
positioning said adhesive layer proximal to a lower energy surface of said article; and
adhering said embellishment to said article by applying pressure and heat to raise the temperature of said adhesive at the glue line above a first activation temperature,
whereby said adhesive layer wets out said low energy surface of said article and said low energy surface of said second layer so as to completely adhere said embellishment to said article.

21. The method of providing an integrated textile embellishment of claim 20, wherein said step of applying a second layer further comprises surface coating with a thermoplastic polyester film through lamination, said polyester film having a thickness within a range of from 0.0025 to 0.005 inches.

22. The method of providing an integrated textile embellishment of claim 21, wherein said thermoplastic polyester film activation temperature is approximately 300° F.

23. The method of providing an integrated textile embellishment of claim 20, wherein said urethane based adhesive layer is from 0.003 to 0.006 inches thick.

24. The method of providing an integrated textile embellishment of claim 1, wherein said urethane based adhesive layer has an activation temperature of approximately 310° F.
